(19) United States
(12) Patent Application Publication
(10) Pub. No.: US 2013/0218998 A1
(43) Pub. Date: Aug. 22, 2013

(54) System, Method, and Computer-Readable Medium for Interactive Collaboration

(71) Applicant: Anacore, Inc., (US)

(72) Inventors: Brandon Fischer, Carmel, IN (US); Adam Cuzzort, Fishers, IN (US)

(73) Assignee: ANACORE, INC., Carmel, IN (US)

(21) Appl. No.: 13/773,015

(22) Filed: Feb. 21, 2013

Related U.S. Application Data
(60) Provisional application No. 61/601,182, filed on Feb. 21, 2012.

(51) Int. Cl. H04L 29/08

(52) U.S. Cl. CPC H04L 67/10
USPC 709/206; 709/204

(57) ABSTRACT

A system, method, and computer-readable medium for facilitating interactions for a computerized collaboration session are disclosed. Such a system includes a distribution network communicatively connected to each of at least two computer stations, wherein, during a collaboration session, the distribution network is configured to synchronize user interactions associated with project data at any of the at least two computer stations such that any user of any of the at least two computer stations is able to observe in real-time or near real-time the user interactions associated with the project data of another user at another one of the at least two computer stations.

### CROSS REFERENCE TO RELATED APPLICATIONS

This patent application claims the benefit of and incorporates by reference herein the disclosure of U.S. Ser. No. 61/601,182, filed Feb. 21, 2012.

### BACKGROUND

With companies today doing business all over the world, it comes as no surprise that many new technologies involve trying to make it easier for people to communicate with others in a different location. For example, the advances in social media and mobile phone technology have made it rather simple to communicate with anyone in the world. However, such advances have not provided the ability to fully collaborate and interact with others on electronic information as if the others were in the same room. Accordingly, there exists a need for a way for people in different locations to collaborate and interact on electronic information as if they were in the same room.

### SUMMARY

The present disclosure discloses a system, method, and computer-readable medium for interactive collaboration. One embodiment of a system for interactive collaboration includes a distribution network communicatively connected to each of at least two computer stations, wherein, during a collaboration session, the distribution network is configured to synchronize user interactions associated with project data at any of the at least two computer stations such that any user of any of the at least two computer stations is able to observe in real-time or near real-time the user interactions associated with the project data of another user at another one of the at least two computer stations.

One embodiment of a method for interactive collaboration includes receiving, using a computer, user interaction information, wherein the user interaction information comprises a user's interaction with project data from any of at least two computer stations and updating, using a processor of the computer, one or more databases with at least a portion of the user interaction information. The method also includes distributing synchronization information to any of the at least two computer stations to allow any user of any of the at least two computer stations to observe the user's interaction with the project data in real-time or near real-time.

The computer-readable medium for interactive collaboration includes code portions to perform the steps described above for the method that are stored therein.

### BRIEF DESCRIPTION OF THE DRAWINGS

The features and advantages of this disclosure, and the manner of attaining them, will be more apparent and better understood by reference to the accompanying drawings, wherein:

FIG. 1 shows a diagram of an exemplary system of facilitating interactive collaboration according to at least one embodiment of the present disclosure.

FIG. 2 shows a flowchart of an exemplary method of facilitating interactive collaboration according to at least one embodiment of the present disclosure.

### DETAILED DESCRIPTION

For the purposes of promoting an understanding of the principles of the present disclosure, reference will now be made to the variations and/or embodiments illustrated in the drawings, and specific language will be used to describe the same. It will nevertheless be understood that no limitation of the scope of this disclosure is thereby intended.

The system, method, and computer-readable medium of the present disclosure facilitate interactions for a computerized collaboration session between users. According to the present disclosure, a computerized collaboration session includes one or more users collaborating on a project by interacting with a document, file, program, or other computerized information at one or more locations. As described herein, the interactions by each of the users can be presented to the other users in real-time or near real-time such that all of the users can participate in the collaboration session. The interactions of each of the users can also be recorded such that a particular session can be retrieved at a later time.

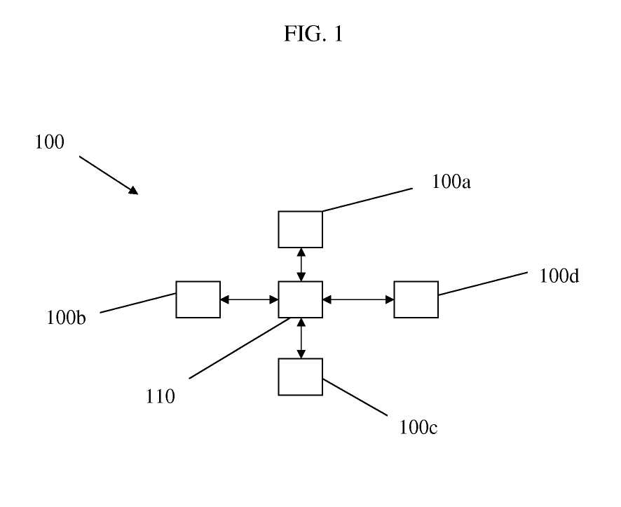

FIG. 1 shows an exemplary system of facilitating a computerized collaboration session 100 according to the present disclosure. In FIG. 1, the system 100 includes a first station 100a, a second station 100b, a third station 100c, and a fourth station 100d (individually, “Station”; collectively, “Stations”). While the number of Stations is shown as four in FIG. 1, it should be noted that there may be more or less Stations included in the system 100 and that each of the Stations may be remote from one another (e.g., different cities, different buildings, and the like). As used herein, a Station may refer to any electronic device or devices that allows a user of one of the Stations to interact in a computerized collaboration session with users in other locations. For example, a Station may include one or more computers, one or more databases, one or more monitors, one or more keyboards, one or more touch screens, one or more mobile phones, one or more microphones, one or more speakers, one or more cameras, and various other devices for communicating with others as would be understood by one of ordinary skill in the art.

As shown in FIG. 1, each of the Stations is connected to a distribution network 110 (e.g., content distribution network). Each of the Stations may be connected to the distribution network 110 via wireless communication, wired communication, and the like. Using the distribution network 110, a computerized collaboration session can be scaled and load balanced to handle any number of users/Stations.

The distribution network 110 may include one or more servers and databases, among other equipment. For example, the distribution network 110 may include a process server to convert project data to compatible file types. It should be noted that the system 100 may utilize software to deliver near-instant visual collaboration, such as, for example, software modeled after multiplayer gaming protocols. The system 100 may also use low-level UDP socket messages to deliver minimal latency between devices. For example, a collaboration socket server may be provided in the cloud environment of the distribution network 110.

As described herein, synchronization refers to the distribution network's ability to update its own database(s) with user interactions and/or project data from each Station and to deliver updates or synchronized information to each Station based on interactions and/or project data from other Stations. The interactions and project data from users operating Stations can include all types of communications and information. The interactions may include manipulations of electronic documentation (e.g., notes, drawings, annotations, and the like), use of web browsers, taking of screenshots, voice recordings received by a microphone of a Station, pictures or video captured by a camera at a Station, and the like. The project data may include electronic documents, files, programs, or other computerized information.

For synchronization, the distribution network 110 may obtain user interactions and/or project data from a Station in a variety of ways. For example, the interactions and/or project data from a Station may be updated in the distribution network's 110 database(s) upon being received. Alternatively or in addition, the interactions and/or project data from a Station may be pulled from the Station at predetermined times, upon an indication of an interaction, and the like. Also, for synchronization, each Station may obtain a user's interactions and/or project data from another Station via the distribution network 110 in a variety of ways. For example, one or more Stations may be updated with the distribution network 110 in real-time or near real-time after the database(s) of the distribution network 110 is updated with interactions and/or project data from another Station. The synchronization of interactions and/or project data among Stations and the distribution network 110 may occur in real-time, near real-time, at various predetermined time intervals, whenever a particular interaction occurs (e.g., voice message, annotation to a document), whenever project data is uploaded or accessed, and the like.

Through synchronization of the distribution network 110 and each Station with respect to interactions and/or project data, users of the Stations can observe (and participate in) the interactions and project data of a user at another Station. For example, users can view the manipulation of documents and drawings by another user on their own monitors or screens, listen to a voice message of another user on their own speaker, and view the pictures or video presented by another user on their own monitors, each in real-time or near real-time. All Stations may be kept in constant coordination with the distribution network 110 to ensure each of the Stations is current with interactions and project data. With this capability, the distribution network 110 facilitates providing all of the interactions and project data that take place during a collaboration session to all of the users and serves as the master repository of all such interactions and shared documentation for the collaboration session. In that regard, the distribution network 110 may be configured to store or record every interaction (or some of the interactions) at each Station in a collaboration session and/or store or record all (or a portion of the) project data in a collaboration session. This record could allow a user or outside party to retrieve the interactions and/or project data in any particular collaboration session at any Station.

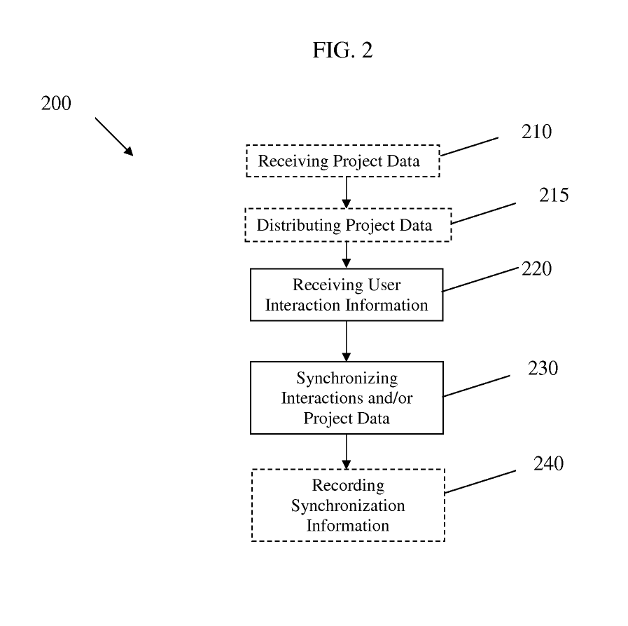

FIG. 2 shows an exemplary method of facilitating a computerized collaboration session 200 according to the present disclosure. In FIG. 2, the method 200 optionally includes the step 210 of receiving project data (e.g., computerized information). The project data may be provided by one of the users or from some other source. For example, a user at a Station may upload various documents. Uploads may be performed from any computer with an internet connection.

Users can upload documents into their project via a web interface and such documents can be synched to every Station that is part of the collaboration session. Once project data has been uploaded and processed, it may be saved into the distribution network 110. It should be noted that the project data may already be stored in the distribution network 110 or in the other Stations. Of course, if the project data is already stored in the distribution network 110 or Stations, then it would not be necessary to receive the same.

As shown in FIG. 2, the method 200 may optionally include the step 215 of initially distributing project data to the user(s) of the project. The project data may be distributed to the user(s) in a variety of different ways, such as, for example, by e-mail, file transfer, unlocking the project materials, and the like. The distribution step 215 may include requiring the users to sign in to initiate the download of or to gain access to the computerized information. Alternatively, the distribution step 215 may be automatically triggered (e.g., after a user provides the project material) or occur by a user accessing the project data.

In FIG. 2, the method 200 includes the step 220 of receiving user interactions. As mentioned above, the user interactions may include manipulations of electronic documentation, use of web browsers, taking of screenshots, voice recordings received by a microphone of a Station, pictures or video captured by a camera at a Station, and the like. As generally described above, the user interactions may be received in various manners and from various devices. For example, a motion detector or touch screen device may detect an interaction by a user and the user's computer station may pass along the detection information.

In FIG. 2, the method 200 also includes the step 230 of synchronizing the interactions of the users and/or the project data in real-time or near real-time. The synchronizing step 230 may include updating one or more database(s) in the distribution network 110 with interactions and/or project data from one or more Stations and distributing synchronization information to one or more Stations regarding interactions and/or project data from the distribution network 110. Also, as shown in FIG. 2, the method 200 may optionally include the step 240 of storing or recording synchronization information in a collaboration session. This record could allow a user or outside party to retrieve the interactions and/or project data in any particular collaboration session at any Station.

As noted above, by synchronizing the interactions and/or the project material, the present disclosure allows users in different locations to collaborate in real-time or near real-time as if each user were in the same location. For example, a collaboration session may involve individuals in China (“First Group”) at a First Station and individuals in the United States (“Second Group”) at a Second Station. During the collaboration session, the First Group may upload an electronic drawing for a product and a document of calculations explaining the reasoning behind the design for the product. Upon being uploaded at the First Station, the electronic drawing and document of calculations may be synchronized with the distribution network 110 and the Second Station so that the users at the Second Station in the United States can view these materials. As a result, while the First Group is discussing the design and the documents justifying the design in China at the First Station, the Second Group can review the drawing and the justification for the design in the United States at the Second Station in real-time or near real-time. In addition, as the First Group resizes or draws content on top of one of the documents, such manipulated content may be simultaneously synched to every other connected Station that is viewing the same project (namely, the Second Group). Furthermore, the Second Group can mark-up the design and/or justification documents (which are displayed at the First Station) so that the First and Second Groups are having a virtual collaboration session with substantially all of the benefits of being in the same room (e.g., looking at and interacting with the same materials in real-time or near real-time, comments, annotations, and the like).

A computer-readable medium, such as a non-volatile storage medium, may comprise the steps of the method for interactive collaboration described above. For instance, the method may be incorporated into a computer program to automatically synchronize the actions of each user for distribution to the other users during a collaboration session. The computer program may be generated in any software language or framework such as Microsoft® NET Framework 4.0, Windows Presentation Foundation 4, or the like. The computer program provides a rich interface that can include multi-touch capabilities, high-definition video, 3D rendering support, and the like. Office document compatibility can be provided via the Microsoft Office Interop .NET Libraries and Microsoft Office 2010. Data storage can utilize the latest Microsoft SQL Server technologies. This solution is designed specifically for Windows 7, utilizing the latest in Windows technologies.

The computer-readable medium for performing the embodiments of the present disclosure may include computer-readable program code portions, such as a series of computer instructions, embodied in the computer-readable medium. It should be understood that the computer-readable program code portions may include separate executable portions for performing distinct functions to accomplish embodiments of the present disclosure. Additionally, or alternatively, one or more of the computer-readable program portions may include one or more executable portions for performing more than one function to thereby accomplish embodiments of the process of the present disclosure.

In conjunction with the computer-readable medium, a computer that includes a processor, such as a programmable-variety processor responsive to software instructions, a hardwired state machine, or a combination of these may be used to carryout the method disclosed above. Such computers may also include memory, which in conjunction with the processor is used to process data and store information. Such memory can include one or more types of solid state memory, magnetic memory, or optical memory, just to name a few. By way of non-limiting example, the memory can include solid state electronic random access memory (RAM); sequential access memory (SAM), such as first-in, first-out (FIFO) variety or last-in, first-out (LIFO) variety; programmable read only memory (PROM); electronically programmable read only memory (EPROM); or electronically erasable programmable read only memory (EEPROM); an optical disc memory (such as a DVD or CD-ROM); a magnetically encoded hard disc, floppy disc, tape, or cartridge media; or a combination of these memory types. In addition, the memory may be volatile, non-volatile, or a hybrid combination of volatile and non-volatile varieties. The memory may include removable memory, such as, for example, memory in the form of a non-volatile electronic memory unit; an optical memory disk (such as a DVD or CD ROM); a magnetically encoded hard disk, floppy disk, tape, or cartridge media; or a combination of these or other removable memory types.

The computers described above may also include a display upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Such computers may also include one or more data entry, such as, for example, a keyboard, keypad, pointing device, mouse, touchpad, touchscreen, microphone, and/or other data entry means known in the art. Each computer also may comprise an audio display means such as one or more loudspeakers and/or other means known in the art for emitting an audibly perceptible output.

While this disclosure has been described as having various embodiments, these embodiments according to the present disclosure can be further modified within the scope and spirit of this disclosure. This application is therefore intended to cover any variations, uses, or adaptations of the disclosure using its general principles. A practitioner may determine in a particular implementation that a plurality of components of the disclosed assembly may be combined in various ways, or that different components or different variations of the components may be employed to accomplish the same results. Each such implementation falls within the scope of the present disclosure as disclosed herein. Furthermore, this application is intended to cover such departures from the present disclosure as come within known or customary practice in the art to which this disclosure pertains.

1. A system for interactive collaboration comprising:
a distribution network communicatively connected to each of at least two computer stations, wherein, during a collaboration session, the distribution network is configured to synchronize user interactions associated with project data at any of the at least two computer stations such that any user of any of the at least two computer stations is able to observe in real-time or near real-time the user interactions associated with the project data of another user at another one of the at least two computer stations.

2. The system of claim 1, wherein the distribution network is further configured to record at least a portion of the user interactions of any user.

3. The system of claim 1, wherein synchronize user interactions comprises distribute input information derived from any of the at least two computer stations to any other computer station of the at least two computer stations.

4. The system of claim 3, wherein the input information comprises motion sensor data.

5. The system of claim 4, wherein the input information further comprises voice data.

6. The system of claim 3, wherein the input information comprises engagement data relating to a touch screen.

7. A method for interactive collaboration, the method comprising:
receiving, using a computer, user interaction information, wherein the user interaction information comprises a user's interaction with project data from any of at least two computer stations;
updating, using a processor of the computer, one or more databases with at least a portion of the user interaction information; and
distributing, using the processor of the computer, synchronization information to any of the at least two computer stations to allow any user of any of the at least two computer stations to observe the user's interaction with the project data in real-time or near real-time.

8. The method of claim 7, further comprising receiving, using the computer, the project data.

9. The method of claim 8, further comprising distributing, using the processor of the computer, the project data to any of the at least two computer stations.

10. The method of claim 9, wherein distributing the project data comprises one or more of sending an email message and initiating a file transfer.

11. The method of claim 7, further comprising recording, using the processor of the computer, at least a portion of the synchronization information.

12. The method of claim 7, wherein the user interaction information comprises the detection of movement from a motion detector.

13. The method of claim 7, wherein the user interaction information comprises the detection of engagement with a touch screen device.

14. A non-transitory computer-readable medium with a computer program for interactive collaboration, the non-transitory computer-readable medium comprising code portions stored therein, the computer-readable medium code portions comprising:
a first executable portion for receiving user interaction information, wherein the user interaction information comprises a user's interaction with project data from any of at least two computer stations;
a second executable portion for updating one or more databases with at least a portion of the user interaction information; and
a third executable portion for distributing synchronization information to any of the at least two computer stations to allow any user of any of the at least two computer stations to observe the user's interaction with the project data in real-time or near real-time.

15. The non-transitory computer-readable medium of claim 14, further comprising a fourth executable portion for receiving the project data.

16. The non-transitory computer-readable medium of claim 15, wherein the fourth executable portion is further configured to distribute the project data to any of the at least two computer stations.

17. The non-transitory computer-readable medium of claim 16, wherein distribute the project data comprises one or more of send an email message and initiate a file transfer.

18. The non-transitory computer-readable medium of claim 14, further comprising a fourth executable portion for recording at least a portion of the synchronization information.

19. The non-transitory computer-readable medium of claim 14, wherein the user interaction information comprises the detection of movement from a motion detector.

20. The non-transitory computer-readable medium of claim 14, wherein the user interaction information comprises the detection of engagement with a touch screen device.
